(19) United States
(12) Patent Application Publication
(10) Pub. No.: US 2025/0332869 A1
(43) Pub. Date: Oct. 30, 2025

(54) UNEVEN TIRE WEAR IDENTIFICATION

(71) Applicant: Ford Global Technologies, LLC, Dearborn, MI (US)

(72) Inventors: Keith Weston, Canton, MI (US); Stuart C. Salter, White Lake, MI (US); Doug Whiteman Smith, Farmington Hills, MI (US); Brendan Francis Diamond, Grosse Pointe, MI (US); Walter LaPlante, Bloomfield Hills, MI (US)

(73) Assignee: Ford Global Technologies, LLC, Dearborn, MI (US)

(21) Appl. No.: 18/651,027

(22) Filed: Apr. 30, 2024

(51) Int. Cl. B60C 11/24; G06V 10/764; G06V 10/82

(52) U.S. Cl. CPC B60C 11/246; B60C 11/243; G06V 10/764; G06V 10/82

(57) ABSTRACT

A system includes a computer including a processor and memory. The memory storing instructions executable by the processor to: receive surface data of a tread area of a vehicle tire on a vehicle; run a machine learning model on the surface data to classify tread characteristics of the tread area; identify uneven wear on the vehicle tire based on the classifications of tread characteristics of the tread area; identify a cause of the uneven wear on the vehicle tire based on the classification of tread characteristics of the tread area; and generate an alert indicating the cause of the uneven wear.

### BACKGROUND

Vehicles typically include a plurality of wheels with each wheel including a rim and a tire. The tires wear with normal usage and are ultimately replaced when worn. Vehicle maintenance such as wheel alignment, wheel balancing, routine tire rotation, and suspension maintenance can aid in even wear of the tires, which increases the effective life of the tires. Uneven wear of one or more of the tires may be caused by, for example, misaligned wheels, one or more imbalanced wheels, and lack of routine tire rotation.

### BRIEF DESCRIPTION OF THE DRAWINGS

FIG. 1 is a perspective view of a vehicle.

FIG. 2 is a cross section of an example tire.

FIG. 3 is a block diagram of a system.

FIG. 4 is a diagram of an example convolutional neural network.

FIG. 5 is a flow chart of an example method.

### DETAILED DESCRIPTION

A system includes a computer including a processor and memory, the memory storing instructions executable by the processor to: receive surface data of a tread area of a vehicle tire on a vehicle; run a machine learning model on the surface data to classify tread characteristics of the tread area; identify uneven wear on the vehicle tire based on the classifications of tread characteristics of the tread area; identify a cause of the uneven wear on the vehicle tire based on the classification of tread characteristics of the tread area; and generate an alert indicating the cause of the uneven wear.

The tread characteristics may include at least one of sipe presence, inboard tread block height, outboard tread block height, and wear bar exposure.

The instructions to identify the cause of uneven wear of the tire may include instructions to compare the classifications of tread characteristics of the tread area of the tire with classifications of tread characteristics of a tread area of another tire of the vehicle.

The instructions may include instructions to receive an identification of a style of the tire, and the instructions to run the machine learning model may include instructions to classify the tread characteristics based on the style of tire.

The instructions may include instructions to train the machine learning model with the classification of the tread characteristics, the identification of uneven wear, and/or the identification of the cause of uneven wear.

The instructions may include instructions to identify a vehicle service action based on the cause of uneven wear on the vehicle tire. The instructions may include instructions to receive service technician input verifying the vehicle service action. The instructions to identify the vehicle service action may be based on driving style of a driver of the vehicle.

The surface data may be an image detected by an image sensor.

The surface data may be three-dimensional data detected by a lidar sensor.

A method includes: receiving surface data of a tread area of a vehicle tire on a vehicle; running a machine learning model on the surface data to classify tread characteristics of the tread area; identifying uneven wear on the vehicle tire based on the classifications of tread characteristics of the tread area; identifying a cause of the uneven wear on the vehicle tire based on the classification of tread characteristics of the tread area; and generating an alert indicating the cause of the uneven wear. The tread characteristics may include at least one of sipe presence, inboard tread block height, outboard tread block height, and wear bar exposure.

Identifying the cause of uneven wear of the tire may include comparing the classifications of tread characteristics of the tread area of the tire with classifications of tread characteristics of a tread area of another tire of the vehicle.

Running the machine learning model may include classifying the tread characteristics based on the style of tire.

The method may include training the machine learning model with the classification of the tread characteristics, the identification of uneven wear, and/or the identification of the cause of uneven wear.

The method may include identifying a vehicle service action based on the cause of uneven wear on the vehicle tire. The method may include receiving service technician input verifying the vehicle service action. The method may include basing the vehicle service action on a driving style of a driver of the vehicle.

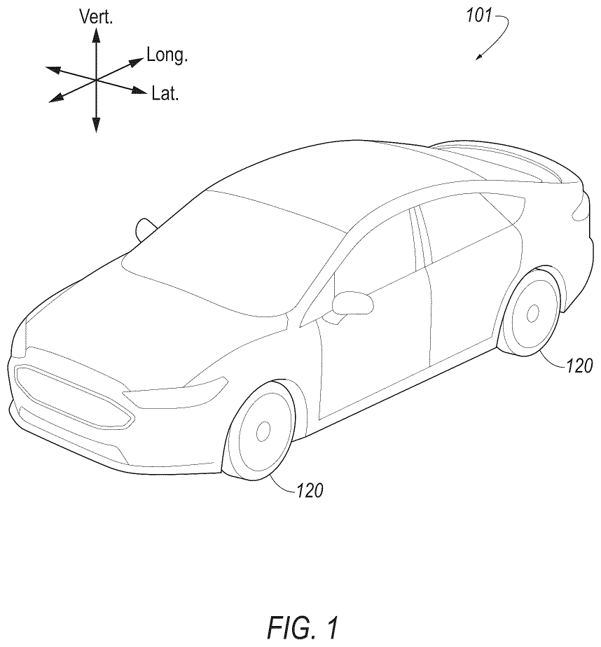

FIG. 1 is a diagram of a computer system 100 including a vehicle computer 105 and a server computer 110. The vehicle computer 105 is a component of a vehicle 101. The server computer 110 is remote from the vehicle 101. The server computer 110 can communicate with the vehicle 101, e.g., the vehicle computer 105, via a network 115.

In the example shown in the Figures, the computer system 100, i.e. the vehicle computer 105 and/or the server computer 110, receives surface data of a tread area of a vehicle tire 120. The computer system 100, i.e. the vehicle computer 105 and/or the server computer 110, runs a machine learning model on the surface data to classify tread characteristics of the tread area. The computer system 100, i.e. the vehicle computer 105 and/or the server computer 110, identifies uneven wear on the vehicle tire 120 based on the classifications of tread characteristics of the tread area. In the event the machine learning model identifies uneven wear of the vehicle tire 120 based on the tread characteristics, the computer system 100, e.g., the vehicle computer 105, identifies the cause of the uneven wear on the vehicle tire 120 based on the classification of tread characteristics. In such examples, the system 100, i.e., the vehicle computer 105 and/or the server computer 110, generates an alert indicating the cause of the uneven wear. The alert may be a visual alert and/or audible alert in the vehicle 101 generated by the vehicle computer 105, e.g., illumination of a light on a dash, a display on an infotainment system, etc. As another example, the alert may be a visual alert and/or audible alert on a user mobile device, e.g., a mobile phone of the user. In such an example, an application on the user mobile device provided by a vehicle original equipment manufacturer, such as FordPass®, may display the alert.

The vehicle 101 may be any suitable type of automobile, e.g., a passenger or commercial automobile such as a sedan, a coupe, a truck, a sport utility vehicle, a crossover vehicle, a van, a minivan, a taxi, a bus, etc. The vehicle 101, for example, may be an autonomous vehicle. In other words, the vehicle 101 may be autonomously operated such that the vehicle 101 may be driven without constant attention from a driver, i.e., the vehicle 101 may be self-driving without human input.

The vehicle 101 includes a propulsion system that generates energy and translates the energy into motion of the vehicle 101. The propulsion system may include a powertrain controller 125. The propulsion system may be a conventional vehicle propulsion system, for example, a conventional powertrain including an internal-combustion engine coupled to a transmission that transfers rotational motion to wheels; an electric powertrain including batteries and one or more electric motors, i.e., a traction motor, that transfer rotational motion to wheels of the vehicle 101; a hybrid powertrain including elements of the conventional powertrain and the electric powertrain; or any other type of propulsion.

The vehicle 101 includes a suspension system 130. The suspension system 130 in some examples may be of a known type. The suspension system 130 may include, for example, springs, shock absorbers, control arms, sway bars, etc., including, in some examples, those that are known. In some examples, the suspension system 130 may be an adjustable suspension system 130. In such examples, the vehicle computer 105 may adjust settings and/or operation of the suspension system 130. For example, the vehicle computer 105 may adjust components of the suspension system 130 to adjust the ride height and/or stiffness of suspension system 130. The vehicle computer 105 may adjust the suspension system 130 based on input from a user of the vehicle 101 and/or based on sensed feedback, e.g., handling, driving surface condition, etc., sensed by sensors 140 of the vehicle 101 during operation of the vehicle 101.

The steering system controls the turning of the wheels to steer the direction of travel of the vehicle 101. The steering system may be a rack-and-pinion system with electric power-assisted steering, a steer-by-wire system, as both are known, or any other suitable system 100. The steering system can include an electronic control unit (ECU) or the like, e.g., a steering controller 135, that is in communication with and receives input from the computer and/or a human driver. The human driver may control the steering system via, for example, a steering wheel.

The vehicle 101 includes sensors 140 that sense surface data of the tires 120. As examples, the vehicle 101 includes sensors 140 that detect images, surfaces, objects, etc., such as image sensors, lidar sensors, radar sensors, etc. The image sensor can detect electromagnetic radiation in some range of wavelengths. For example, the image sensor may detect visible light, infrared radiation, ultraviolet light, or some range of wavelengths including visible, infrared, and/or ultraviolet light. For example, the image sensor can be a charge-coupled device (CCD), complementary metal oxide semiconductor (CMOS), or any other suitable type. As another example, the sensor 140 may be a lidar (light detecting and ranging) sensor that detects the three-dimensional contours of the tread 150 of the tire 120. As another example, the sensor 140 may be a Time of Flight (ToF) sensor that detects the three-dimensional contours of the tread 150 of the tire 120. The sensor 140 (image sensor, lidar sensor, and/or radar sensor) may be fixed relative to the vehicle 101, e.g., fixedly mounted to a body of the vehicle 101. The sensor 140 may sense the vehicle 101 on which the sensor 140 is mounted and/or other vehicles. Specifically, the sensor 140 may detect images and/or surfaces of the vehicle 101 on which the sensor 140 is mounted and/or may detect images and/or surfaces of other vehicles. In some examples, the sensor 140 may be mounted in a wheel well of the vehicle 101 and may be aimed at the tread 150 of the tire 120.

The vehicle 101 includes more than one wheel, and typically includes four wheels. Each wheel includes a rim and a vehicle tire 120. The vehicle tires 120 contact a driving surface, such as a road, and the vehicle tires 120 transfer motion from a propulsion system of the vehicle 101 to the driving surface. The rim connects the vehicle tire 120 to the propulsion system and transmits motion from the propulsion system to the vehicle tire 120. The vehicle tire 120 may be rubber. The vehicle tire 120 may be pneumatic, i.e., inflated with gas such as air, nitrogen, etc.

The vehicle tire 120 includes a sidewall 145 and a tread 150. The sidewall 145 is typically sealed to the rim and the tread 150 contacts the driving surface. The sidewall 145 and the tread 150 are unitary. The tread 150 may include tread blocks 155 extending circumferentially about the vehicle tire 120. The tread blocks 155 include an outer circumferential surface 160 that contacts the driving surface. In such examples, the tread 150 includes circumferential grooves 165 elongated circumferentially about the tire 120 between the tread blocks 155. The height of the tread block 155 may be measured from the outer circumferential surface 160 to the bottom of the circumferential groove 165. The depth of the circumferential groove 165 may be measured from the outer circumferential surface 160 to the bottom of the circumferential groove 165. The tread 150 may include lateral grooves 170 in the tread blocks 155. In such examples, the lateral grooves 170 are elongated in directions transverse to the circumferential grooves 165. The depth of the lateral grooves 170 may be measured from the outer circumferential surface 160 to the bottom of the lateral grooves 170. The tread 150 may include sipes 175 in the tread blocks 155. The sipes 175 are slit-shaped voids in the tread blocks 155. The sipes 175 may be elongated transverse to the circumferential grooves 165. The sipes 175 open when at the driving surface to grip the driving surface. The sipes 175 may displace water and snow from between the tread block 155 and the driving surface when the vehicle 101 is driving in such conditions. The circumferential grooves 165 extend a first distance radially inwardly from the outer circumferential surface 160, i.e., has a depth, and the sipes 175 may extend radially inwardly from the outer circumferential surface 160 a second distance less than the first distance. In other words, the depth of the sipes 175 is less than the depth of the circumferential grooves 165. Accordingly, during wear of the vehicle tire 120, the sipes 175 may be worn away before the tread block 155 is worn to the bottom of the circumferential groove 165. The design of the tread 150, e.g., the tread blocks 155, the circumferential groove 165, the lateral grooves 170, the sipes 175, etc., may be, in some examples, be of known types.

The tread 150 may include wear-indicating formations. As an example, the tread 150 may include wear bars 180 in one of the circumferential grooves 165. In such examples, the wear bar 180 extends radially outwardly from the circumferential groove 165. The height of the wear bar 180 in the circumferential groove 165 is less than the depth of the circumferential groove 165 such that the wear bar is recessed from the outer circumferential surface 160 when the vehicle tire 120 is new. As the tread block 155 wears during use, exposure of the wear bar 180 at the circumferential surface indicates wear of the vehicle tire 120. As another example, the tread 150 may include dimples at the outer circumferential surface 160. As another example, the tread 150 may include wear-indicating slits extending radially inwardly from the outer circumferential surface 160. The wear-indicating slits have less depth from the outer circumferential surface 160 than the circumferential groove 165, and therefore may be worn away before the tread block 155 is worn to the bottom of the circumferential groove 165. In such examples, the wear-indicating slits indicate wear, and wear-indicating slits of varying depth indicate degree of wear.

Measurements of tread characteristics include, for example, measurements of the height of the tread blocks 155 (height each tread block 155 relative to other tread blocks 155 on the same tire 120 and/or other tires 120 of the same vehicle 101), measurement of the depth of each circumferential groove 165, measurement of depth of each lateral grooves 170, measurement of presence and/or absence of sipes 175, measurements of presence and/or absence wear indicating features, e.g., dimples, measurements of height of wear bars 180, etc. The measurement of tread characteristics may include relative differences in each of these measurements (i.e., tread block height, circumferential groove depth, lateral grooves depth, presence and/or absence of sipes 175, presence and/or absence of dimples, wear bar height) around the circumference of the vehicle tire 120. The measurement of tread characteristics may include relative differences in each of these measurements (i.e., tread block 155 height, circumferential groove depth, lateral grooves depth, presence and/or absence of sipes 175, presence and/or absence of dimples, wear bar height) in a cross-tire direction.

During normal driving of the vehicle 101, the rubber of the tire wears. Vehicle maintenance such as wheel alignment, wheel balancing, routine tire rotation, and suspension maintenance can aid in even wear of the tires 120, which increases the effective life of the tires 120. Uneven wear of one or more of the tires 120 may be caused by, for example, misaligned wheels, one or more imbalanced wheels, and lack of routine tire rotation. Damaged or worn suspension components may result in uneven tread wear, such as a damaged or worn shock absorber, a damaged or worn wheel bearing, a damaged or worn tie rod, etc. Uneven tread wear of a vehicle tire 120 includes a difference in wear of the tread 150 in a cross-wheel direction and/or around the circumference of the vehicle tire 120. Feathering is one example of uneven tread wear in which the one edge of a tread block 155 (i.e., the inboard edge or the outboard edge) is smooth and the other edge of the tread block 155 is sharp. Cupping is an example of uneven tread wear in which a smooth patches occur circumferentially about the tire 120. Camber wear is an example of uneven tread wear in which one side of the tire 120, i.e., an inboard side or an outboard side, wears faster than the other side. Center wear is an example of uneven tread wear in which the middle of the tire 120 tread 150 wears faster than an outboard portion of the tire 120 tread 150 and an inboard portion of the tire 120 tread 150, which may be caused by overinflation of the tire 120 or lack of routine rotation of tires 120. Uneven tread wear can be identified with the measurements of tread characteristics described herein. Specifically, feathering, cupping, camber wear, center wear, and other types of uneven tread wear may be identified based on measurements of tread characteristics such as tread block height, circumferential groove depth, lateral grooves depth, presence and/or absence of sipes 175, presence and/or absence of dimples, wear bar height, including consideration of such measurements relative to each other taken around the circumference of the same vehicle tire 120, taken cross-tire on the same vehicle tire 120, and/or relative to other vehicle tires 120 of the same vehicle 101.

As set forth above, the computer system 100 runs a machine learning model to process the surface data, e.g., images, of the tread 150. As set forth below, the machine learning model is saved on the computer system 100. For example, the machine learning model may be trained and saved on the server computer 110, in which case the machine learning model is accessible by or periodically deployed to the vehicle computers 105 of multiple vehicles 101. In such examples, the machine learning model may be specific to a vehicle 101 model, trim level, etc.

As an example, in which the surface data of the tread 150 is an image, the machine learning model takes the images of the tires 120 as inputs and classifies tread characteristics of the tires 120 based on the input images. In some examples, one or more images of one or more of the vehicle tires 120 may be used to classify several tread characteristics of more than one of the vehicle tires 120 of a vehicle 101, e.g., all of the vehicle tires 120 of the vehicle 101. In such examples, the machine learning model may take all of the classifications of tread characteristics from more than one vehicle tire 120, e.g., all of the vehicle tires 120, as inputs to identify uneven wear on any one or more of the vehicle tires 120. In the event the machine learning model identifies uneven wear of one or more of the vehicle tires 120 based on the tread characteristics, the computer system 100 maps the characteristics of uneven wear to the root cause of the uneven wear of the vehicle tire 120. In such an event, the computer system 100 may generate an alert indicating the cause of the uneven wear to the user and/or a service center.

With the cause of uneven wear identified, appropriate service may be provided to the vehicle 101 to replace the tire 120 or to service the tire 120, e.g., to rotate the tire 120, remove a foreign object from the tire 120, adjust the balance of a wheel of which the tire 120 is a part of, etc. The identification of the cause of uneven wear can also be used to adjust and/or repair components of the vehicle 101. For example, the suspension system 130 of the vehicle 101 may be adjusted to align the wheels. A service technician may use the identification of the cause of uneven tread wear to service the vehicle 101, e.g., balance one or more wheels, rotate the tires 120 of the vehicle 101, align the wheels, replace vehicle tires 120, service or replace suspension components, etc. Specifically, the service technician may examine the vehicle 101 to verify the identification of the cause of uneven wear made by the machine learning model. The service technician may provide input to the machine learning model on the computer system 100 to verify or dispute the identification made by the machine learning model to further train the machine learning model. For example, the service technician may provide input to the machine learning model on the server computer 110 to further train the machine learning model. In such an example, the further trained machine learning model may be accessible by vehicles 101 and/or may be deployed to vehicles 101 through periodic updates.

The system 100 includes at least one processor and memory storing instructions executable by the processor. The processor and memory of the system 100 may be, for example, the processor and memory of the vehicle computer 105 and/or the server computer 110.

The vehicle computer 105 has a processor and memory storing instructions executable by the processor. For example, the vehicle computer 105 may include programming to operate one or more of vehicle 101 propulsion, brakes, suspension, steering, image sensors 140, climate control, interior and/or exterior lights, etc. The computer is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The vehicle computer 105 can thus include a processor, a memory, etc. The memory of the vehicle computer 105 can include media for storing instructions executable by the processor as well as for electronically storing data and/or databases, and/or the vehicle computer 105 can include structures such as the foregoing by which programming is provided. The vehicle computer 105 can be multiple computers coupled together. In some examples, the vehicle computer 105 may be a body control module of the vehicle 101.

The vehicle computer 105 may transmit and receive data through a communications network 185 of the vehicle 101. The communications network 185 may be, e.g., a controller area network (CAN) bus, Ethernet, WiFi, Local Interconnect Network (LIN), onboard diagnostics connector (OBD-II), and/or any other wired or wireless communications network. The vehicle computer may 105 be communicatively coupled to sensors 140 of the vehicle 101 (e.g., image sensors, lidar sensors, etc., that detect images, surfaces, objects, etc.), a propulsion system of the vehicle 101, an adaptive suspension system 130 of the vehicle 101, a steering system 100, and other components via the communications network 185. Via the communication network 185, the vehicle computer 105 may transmit messages to various devices in the vehicle 101 and/or receive messages from the various devices, i.e., controllers, actuators, sensors 140, etc. Alternatively, or additionally, in cases where the vehicle computer 105 includes multiple vehicle computers 105, the vehicle communication network 185 may be used for communications between devices represented as the vehicle computer 105 in this disclosure.

In addition, the vehicle computer 105 may be configured for communicating through a vehicle-to-infrastructure (V2X) interface 190 with the server computer 110, e.g., a cloud server, via a network, which includes hardware, firmware, and software that permits vehicle 101 to communicate with a remote server computer 110 via the network 115, such as wireless Internet (WI-FI®) or cellular networks. The V2X interface 190 may accordingly include processors, memory, transceivers, etc., configured to utilize various wired and/or wireless networking technologies, i.e., cellular, BLUETOOTH®, Bluetooth Low Energy (BLE), Ultra-Wideband (UWB), Peer-to-Peer communication, UWB based Radar, IEEE 802.11, and/or other wired and/or wireless packet networks or technologies. The vehicle computer 105 may be configured for communicating with other vehicles through a V2X interface 190 using vehicle-to-vehicle 101 (V-to-V) networks, i.e., according to including cellular communications (C-V2X) wireless communications cellular, Dedicated Short Range Communications (DSRC) and/or the like, i.e., formed on an ad hoc basis among nearby vehicles or formed through infrastructure-based networks. The vehicle computer 105 also includes nonvolatile memory such as is known. The vehicle computer 105 can log data by storing the data in nonvolatile memory for later retrieval and transmittal via the vehicle communication network 185 and the vehicle 101 to infrastructure (V2X) interface 190 to a server computer 110 or user mobile device.

As already mentioned, generally included in instructions stored in the memory and executable by the processor of the vehicle computer 105 is programming for operating one or more vehicle 101 components, i.e., propulsion, braking, suspension, steering, etc. Using data received in the vehicle computer 105, e.g., data from the server computer 110, the vehicle computer 105 may make various determinations and/or control various vehicle 101 components and/or operations. For example, the vehicle computer 105 may include programming to adjust an adjustable suspension system 130.

The server computer 110 typically has features in common, e.g., a computer processor and memory and configuration for communication via a network, with the vehicle computer 105 and the V2X interface 190, and therefore these features of the server computer 110 are not described further. The server computer 110 can be used to develop and train software that can be transmitted to the vehicle computer 105.

As set forth above, the computer system 100 runs a machine learning model. As one example, the machine learning model may be a convolutional neural network 200, as described below. The machine learning model, e.g., the convolutional neural network 200, is saved on the computer system 100, e.g., on the vehicle computer 105 and/or the server computer 110. As an example, the server computer 110 may develop and train the machine learning model. The machine learning model may be saved on the server computer 110 or the vehicle computer 105. In an example in which the machine learning model is saved on the server computer 110, the vehicle computer 105 may access the machine learning model through the network. In such an example, surface data, e.g., images, from multiple vehicles are used to train the machine learning model when the machine learning model is deployed. In such examples, an application provided by a vehicle original equipment manufacturer, such as FordPass®, may provide an interface to transmit images of the tread 150 to the server computer 110. In an example in which the machine learning model is saved on the vehicle computer 105, the vehicle computer 105 may transmit data from image processing, including classifications of tread characteristics, identification of cause of uneven tread wear, and verification or dispute of the identification of the cause by a service technician, to the server computer 110 to train the machine learning model. In such an example, the trained machine learning model can be deployed to multiple vehicles through updates.

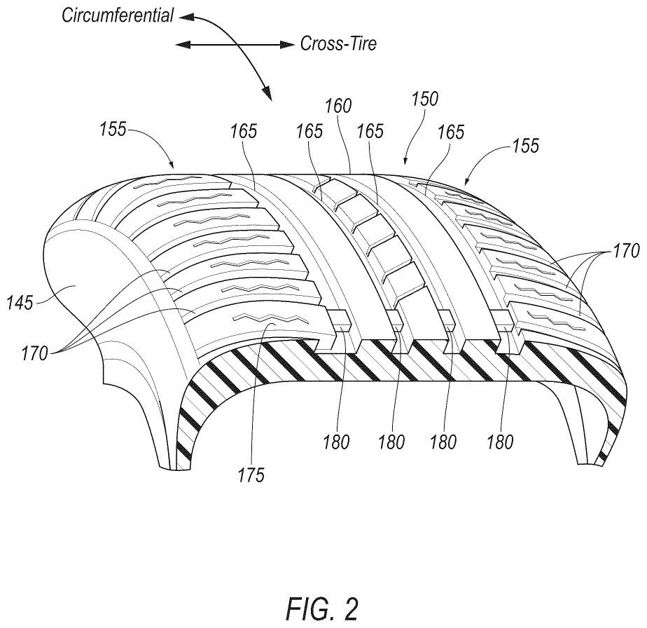

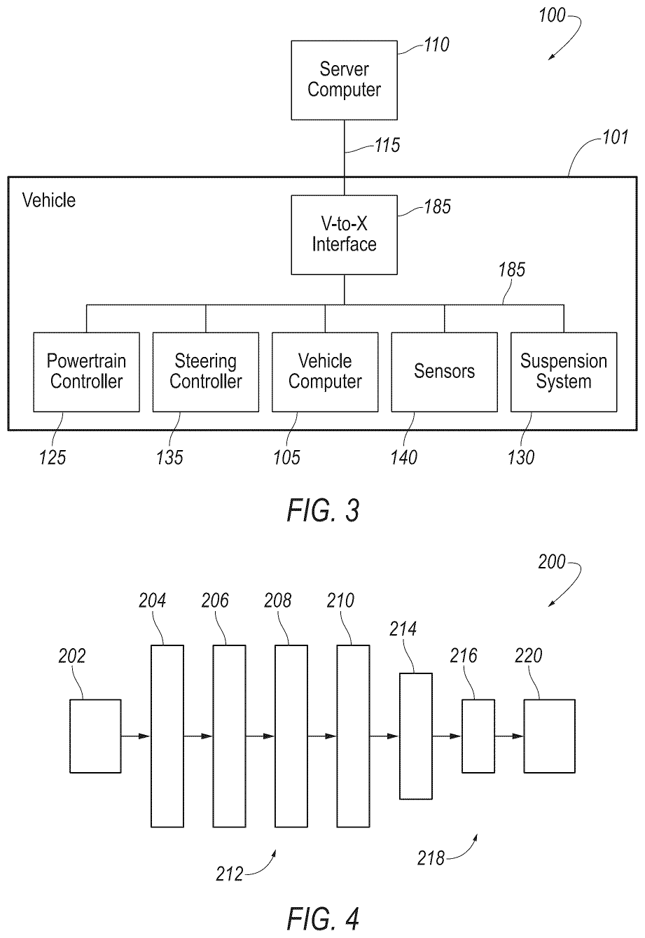

FIG. 2 is a diagram of an example convolutional neural network 200. The convolutional neural network 200 can input surface data 202 and output a prediction. In some examples, the surface data 202 input to the convolutional neural network 200 may be two-dimensional data such as an image, e.g., an image detected by an image sensor as described above. In such an example, a prediction 220 of the convolutional neural network 200 is two-dimensional. In other examples, the surface data 202 input to the convolutional neural network 200 may be three-dimensional data. In such examples, the surface data 202 input to the convolutional neural network 200 may be 3-dimensional data from a lidar sensor, ToF sensor, etc., as discussed above. In such an example, a prediction 220 of the convolutional neural network 200 is three-dimensional. Examples of systems that predict three-dimensional shapes Mesh R-CNN and C3DPO. An example three-dimensional artificial intelligence (AI) library is PyTorch3d.

The convolutional neural network 200 includes convolutional layers 204, 206, 208, 210, (collectively convolutional layers 212) and fully connected layers 214, 216 (collectively fully connected layers 218). Convolutional layers 212 receive as input surface data, e.g., image data, and convolve the surface data using convolutional kernels which are typically kXk neighborhoods where k is a small number such as 3, 5, 7, 9, etc. The operation performed by the convolution kernel is determined by the numbers included in the kXk neighborhoods, called weights. Fully connected layers 218 calculate linear or nonlinear algebraic functions based on their input. They are referred to as fully connected because any input value can be combined with any other input value. The linear or nonlinear algebraic function determined by fully connected layers 218 is determined by parameters also called weights.

Convolutional neural networks 200 can be trained by compiling a training dataset that includes surface data 202, e.g., images, and ground truth data which indicates a user selected prediction to be output from the convolutional neural network 200 in response to input surface data 202, e.g., an input image. In this example, a prediction includes object detection data, e.g. object locations in either global or pixel coordinates and an object label that identifies the object. In such an example, the convolutional neural network 200 classifies the object in the image. The objects to be classified can be, for example, tread characteristics of the tire 120 including details of the surface of the tire 120, such as sipes 175, inboard tread depth, outboard tread depth, wear bar height, depth of the circumferential grooves 165, etc. As set forth below, the machine learning model classifies the tread characteristics in the surface data, e.g., the image, based on size, shape, location, etc., of the tread characteristics.

Output from a neural network 200 is referred to herein as a prediction 220. Ground truth is determined by a process separate from the neural network 200 and can include human inspection and measurement of the surface data 202, e.g., image data, and the scene that was imaged. The images are images of the tread 150 of tires 120. Training the convolutional neural network 200 can include processing each image in the training dataset hundreds or thousands of times, each time comparing the output prediction to the ground truth to determine a loss function. The loss function is back propagated through the fully connected layers and the convolutional layers from back to front, altering the weights included in the fully connected layers 218 and convolutional layers 212 to minimize the loss function. When the loss function is sufficiently minimized, e.g., when changing the weights does not make the loss function smaller, the convolutional neural network 200 may be considered to be trained, and the current weights are saved. After training, the neural network 200 takes new surface data 202, e.g., a new image, of a tread 150 of a tire 120 as input and outputs a predicted classification. The training of the neural network 200 can continue after the initial training, e.g., with images of the tread 150 of tires 120 and verification of classifications by a service technician. In some examples, the machine learning model may map predicted classifications of the tread characteristics to the cause of uneven wear of the tread 150 and identification of vehicle service action to address the uneven wear. In such examples, the machine learning model is trained to perform such mapping. The training of the neural network 200 in such examples can continue after the initial training, for example, with verification of the identification of the cause of uneven wear of the tread 150 and/or identification of the vehicle service action to address the uneven wear by a service technician.

The outputs from each convolutional layer 212 and each fully connected layer 218 to the next layer in the convolutional neural network 200 are called tensors. The tensor is output from a layer via an activation function that can condition the output. For example, ReLu activation conditions the output to be positive. Output from a convolutional layer 212 or fully connected layer 218 via an activation function is called an activation tensor herein. The activation tensors output by the layers, of a trained convolutional neural network 200 in response to a particular input image can be used to characterize the convolutional neural network 200 and will be used herein to determine similarities between two or more convolutional neural networks, for example.

After the machine learning model is trained, the machine learning model is run on vehicles 101. The machine learning model is run either on the vehicle computer 105 of each vehicle 101 or on the server computer 110 and accessed by the vehicle computers 105. The machine learning model analyzes one or more images of the tires 120 of the vehicle 101 to analyze the tread characteristics of the tires 120. Specifically, the machine learning model may classify tread characteristics of the tread 150, and the system 100, e.g., using the machine learning model, may identify that one or more of the tires 120 has uneven wear based on the classifications of tread characteristics. If uneven wear is identified, then the system 100, e.g., using the machine learning model, may identify the cause of the uneven wear on the vehicle tire 120 based on the classification of wear characteristics of the tread 150.

The memory of the system 100, e.g., the memory of the vehicle computer 105 and/or the server computer 110, stores instructions to receive a tire identifier. The machine learning model may receive a tire identifier as an input. The machine learning model may have different datasets for different style tires 120. The tire identifier may be a style identification of the vehicle tire 120. The style identification of the tire 120 is a name, letters, and/or numbers assigned to a line of tires 120 produced by the manufacturer of the tire 120. As another example, the tire identifier may be a tire identification number (TIN), which is a number assigned by the manufacturer of the vehicle tire 120 and is unique to each individual tire 120. The tire identifier is used by the machine learning model to access the dataset associated with that particular style of tire 120, including the measurements of tread characteristics of that type of tire 120 when new and when worn, as trained as described above.

The memory of the system 100 includes instructions to classify the tread characteristics of the tire 120 based on the tire identifier. Specifically, the machine learning model may be trained on several different types of tires 120, i.e., all major makes, models, and sizes of tires 120, including the tread characteristics of such tires 120 when new and during various stages of wear. Thus, the training and the use of the machine learning model is specific to the tire identifier.

The memory of the system 100 includes instructions to receive surface data of a tread area of the vehicle tire 120. The tread area may be part of the entire tread 150 of the tire 120. The surface data may be detected by a sensor 140 of the vehicle 101. For example, the surface data may be an image of a tread area of a vehicle tire 120 taken by an image sensor of the vehicle 101 and/or another vehicle in the vicinity of the vehicle 101. As another example, the surface data may be lidar data taken by a lidar sensor of the vehicle 101 and/or another vehicle in the vicinity of the vehicle 101. In some examples, the camera or lidar sensor may be a component of the vehicle 101. For example, camera and/or a lidar sensor may be mounted in a wheel well of the vehicle 101 and aimed at the tread 150 As another example, the camera or lidar sensor may be a component of another vehicle 101, which may transmit the surface data of the sensed vehicle 101 through the network 115 to the server computer 110. As another example, the cameral or lidar sensor may be a component of a personal mobile device of a user of the vehicle 101, e.g., a mobile phone. In such examples, the mobile phone may transmit surface data, e.g., an image or lidar data, to the server computer 110 through the network 115. As an example, an application provided by a vehicle 101 original equipment manufacturer, such as FordPass®, may provide an interface to transmit surface data of the tread 150 to the server computer 110. As another example, the camera or lidar sensor may be a component of a service tool used by a service technician, e.g., a handheld scanner, stationary device positioned to scan tires 120 at a service center, a body-worn device, etc. In such examples, the surface data may be transmitted to the server computer 110 through an application such as FordPass®.

The surface data may cover the surface of the tire 120 from an inboard tread 150 to an outboard tread 150, i.e., the entire face of the tire 120 in a cross-tire direction. The surface data may cover one or more portions of the circumference of the tire 120 or may cover the entire circumference of the tire 120. Surface data along the circumference of the tire 120 may be gathered by scanning the circumference of the tire 120 with the camera or lidar sensor, or by stitching together sets of surface data gathered in separate detections.

The system 100 may analyze surface data of all four tires 120 of one vehicle 101. The analysis of the surface data of all four tires 120 and the relative wear of the four tires 120 may be inputs to the machine learning model to identify the cause of the uneven wear of one or more of the tires 120 of the vehicle 101, as described further below.

The memory of the system 100 includes instructions to run the machine learning model on the surface data, e.g., an image, of the tread area to classify tread characteristics of the tread area. As set forth above, the tread characteristics can be, for example, details of the surface of the tire 120, such as sipes 175, inboard tread depth, outboard tread depth, wear bar height, depth of the circumferential grooves 165, etc. As examples, the tread characteristics classifications can include “sipe presence”, “sipe absence,” “inboard tread depth worn”, “inboard tread depth not worn,” “outboard tread depth worn,” “outboard tread depth not worn,” “wear bar height worn,” “wear bar height not worn,” and “first circumferential groove 165 depth worn”, “N^{th} circumferential groove 165 depth worn,” “first circumferential groove 165 depth not worn”, “N^{th} circumferential groove 165 depth not worn.” Such tread characteristics classifications can also include magnitudes of these tread characteristics, e.g., a depth or depth range of the inboard tread 150, the outboard tread 150, the wear bar, etc. Tread characteristics classifications may also include differences in sipe presence/absence in a cross-tire direction and/or differences in sipe presence/absence circumferentially about the tire 120. Tread characteristics classifications may also include relative differences in tread depth of two or more treads 150, for example, inboard tread depth relative to outboard tread depth, in a cross-tire direction. Tread characteristics classifications may also include differences in depth of any of the treads 150 circumferentially about the tire 120.

The system 100 analyzes the tread characteristics classifications for wear patterns of the four tires 120 of the vehicle 101 and classifies the wear of each tire 120. The classification of wear on each tire 120 may be based both on analysis of the tread characteristics classifications of that tire 120 and the other tires 120 of the vehicle 101. In other words, tread characteristics classifications of one tire 120 may indicate the cause of wear of that tire 120, and also the tread characteristics classifications of the other tires 120 of the vehicle 101 may indicate the cause of wear of any one tire 120.

As one example, for each tire 120, the machine learning model may map the combination of tread characteristic classifications for each of the four tires 120 to a wear classification for each tire 120. As another example, other software of the vehicle computer 105 or the server computer 110 may identify the wear pattern based on the tread characteristics classifications made by the machine learning model, e.g., using a lookup table with the tread characteristics classifications made by the machine learning model as the input. The system 100 may classify the wear of each tire 120 as “even wear—no action,” “rotate tires,” “replace—worn,” “foreign object detected,” and “uneven wear.” The system 100 may classify a set of four tires 120 and/or any of the individual tires 120 as more than one tire wear classification. In examples in which the machine learning model maps the combination of tread characteristic classifications for each of the four tires 120 to a cause of uneven wear for at least one of the tires 120, the machine learning model may be trained to map in such a fashion based on surface data as described above.

In the event the system 100 classifies the wear each of the four tires 120 of a vehicle 101 as “even wear—no action,” the system 100 has no reason, and does not, alert a user of the vehicle 101 nor a service center of recommended maintenance. The system 100 classifies the wear of the tires 120 as “even wear—no action” when the tires 120, considered individually and relative to each other, are worn evenly, within predetermined thresholds, and have tread depth over a minimum threshold.

In the event the system 100 classifies the wear of one or more of the tires 120 as “rotate tires,” the system 100 alerts the user of the vehicle 101, e.g., the driver, and/or a service center that the vehicle 101 should be serviced and that the tires 120 should be rotated. The system 100 classifies the wear of the tires 120 as “rotate tires” when the tires 120, considered individually and relative to each other, are worn unevenly within a predetermined range. In other words, the tires 120 have worn as expected absent service requirements for the wheels or other parts of the vehicle 101 that would lead to unexpected uneven tire wear.

In the event the system 100 classifies the wear of one or more of the tires 120 as “replace—worn,” the system 100 alerts the user of the vehicle 101, e.g., the driver, and/or a service center that the vehicle 101 should be serviced along with a notification of which tire 120 needs replacement. The system 100 classifies the wear of the tires 120 as “replace—worn” when the tread 150 of the tire 120 is worn below a predetermined threshold and is consistent expected usage and lifetime of the tire 120. In other words, the tires 120 have worn as expected absent service requirements for the wheels or other parts of the vehicle 101 that would lead to unexpected tire wear.

In the event the system 100 classifies the wear of one or more of the tires 120 as “foreign object detected,” the system 100 alerts the user of the vehicle 101, e.g., the driver, and/or a service center that the vehicle 101 should be serviced along with a notification of which tire 120 needs service. The system 100 classifies the wear of the tires 120 as “foreign object detected” when the machine learning model identifies a foreign object, such as a nail, screw, etc., in the tread 150. The system 100 may identify that the foreign object is at a location of the tread 150 that can be repaired or a location of the tread 150 that would require replacement. Upon receipt of location information, a service technician can verify whether the foreign object is at a location that requires tire 120 repair or tire 120 replacement.

In the event the system 100 classifies the wear of one or more of the tires 120 as “uneven wear,” the system 100 alerts the user of the vehicle 101, e.g., the driver, and/or a service center that the vehicle 101 should be serviced. The system 100 classifies the wear of the tires 120 as “uneven wear” when the tread 150 of the tire 120 is unevenly worn above predetermined thresholds and the wear is not consistent with expected usage and lifetime of the tire 120. The uneven wear may be uneven wear of tread characteristics above predetermined thresholds in a cross-tire direction and/or about the circumference of the tire 120.

The memory of the system 100 stores instructions to identify the cause of the uneven wear on the vehicle tire 120 based on the tread characteristics classifications of the tread area in the event the system 100 classifies the wear of one or more of the tires 120 as “uneven wear.” As one example, based on the combination of tread characteristics classifications for each tire 120 individually and all four tires 120 in combination, the machine learning model may map the tread characteristic classifications to a wear cause classification for each tire 120. As another example, other software of the vehicle computer 105 or the server computer 110 may identify the wear cause classification based on the tread characteristics classifications made by the machine learning model for the four tires 120, e.g., using a lookup table with the tread characteristics classifications made by the machine learning model as the input.

The system 100 may classify the wear cause of each tire 120 as, for example, “wheel alignment,” wheel imbalance,” “positive toe,” “negative toe,” “camber,” “overinflation,” “underinflation,” “tie rod adjustment,” “tie rod replacement,” shock absorber replacement,” and “wheel bearing replacement.” In examples in which the machine learning model maps the combination of tread characteristic classifications and/or tread 150 wear classifications for each of the four tires 120 to a cause of uneven wear for at least one of the tires 120, the machine learning model may be trained to map in such a fashion based on surface data as described above.

The memory of the system 100 stores instructions to generate an alert indicating the cause of the uneven wear. The alert may be a visual alert and/or audible alert in the vehicle 101 generated by the vehicle computer 105, e.g., illumination of a light on a dash, a display on an infotainment system 100, etc. As another example, the alert may be a visual alert and/or audible alert on a user mobile device, e.g., a mobile phone of the user. In such an example, an application on the user mobile device provided by a vehicle 101 original equipment manufacturer, such as FordPass®, may display the alert.

The memory of the system 100 stores instructions to identify a vehicle service action based on the classification of tread characteristics of the tread area. In some examples, the vehicle service action may be related to the cause of uneven wear. The vehicle service action may eliminate or alleviate the cause of uneven wear. For example, in an example in which the cause of uneven wear is “tie rod adjustment,” the vehicle service action may be instruction for a service technician to adjust the tie rod. The vehicle service action may include detailed instructions for the service technician. The detailed instructions to the service technician are determined based on the classification of tire 120 characteristics, classification of wear, and/or classification of wear cause. In such examples, the machine learning model may be trained to map the classification of tire 120 characteristics, classification of wear, and/or classification of wear cause to the vehicle service action, and detailed instructions for the service technician, based on surface data as described above. As an example, in the example in which the cause of uneven wear is “tie rod adjustment,” the vehicle service action may include instruction for direction and magnitude of adjustment. As another example, in an example in which the cause of uneven wear is “positive toe,” “negative toe,” or “camber,” as examples, the vehicle service action may be a command to an adaptive suspension system 130 of the vehicle 101 to adjust. Specifically, the vehicle service action includes detailed instructions to command the adaptive suspension system 130 to adjust.

The vehicle service action, and any detailed instructions for the service technician accompanying the vehicle service action, may be provided to the service technician by the system 100 through an interactive service manual. The interactive service manual may provide the service technician with details of the classification of tire 120 characteristics, classification of wear, and/or classification of wear cause to the vehicle service action. The interactive service manual may provide images of the tread 150 for use by the service technician.

The service technician may confirm or dispute the classification of tire 120

characteristics, classification of wear, and/or classification of wear cause to the vehicle service action after inspecting and servicing the vehicle 101. This confirmation or dispute further trains the machine learning model. The service technician may input the confirmation or dispute to the system 100 through the interactive service manual.

In addition to using the tire 120 characteristics classifications, and wear classification, and wear cause classification, the system 100 may identify the vehicle service action, and the associated detailed instructions for the service technician, based on driving style of a driver of the vehicle 101. For example, the driving style may include vehicle 101 data (such as total mileage, highway mileage, city mileage, etc.) and driver-specific data indicating driving habits (such as corner speeds, average acceleration from standstill, etc.). Such driving habits can affect wear of tire 120 tread 150 and can be considered in identifying the details of the vehicle service action. For example, in examples where the vehicle service action can include ranges of adjustment, certain driving habits may cause the vehicle service action to move to one side of the range.

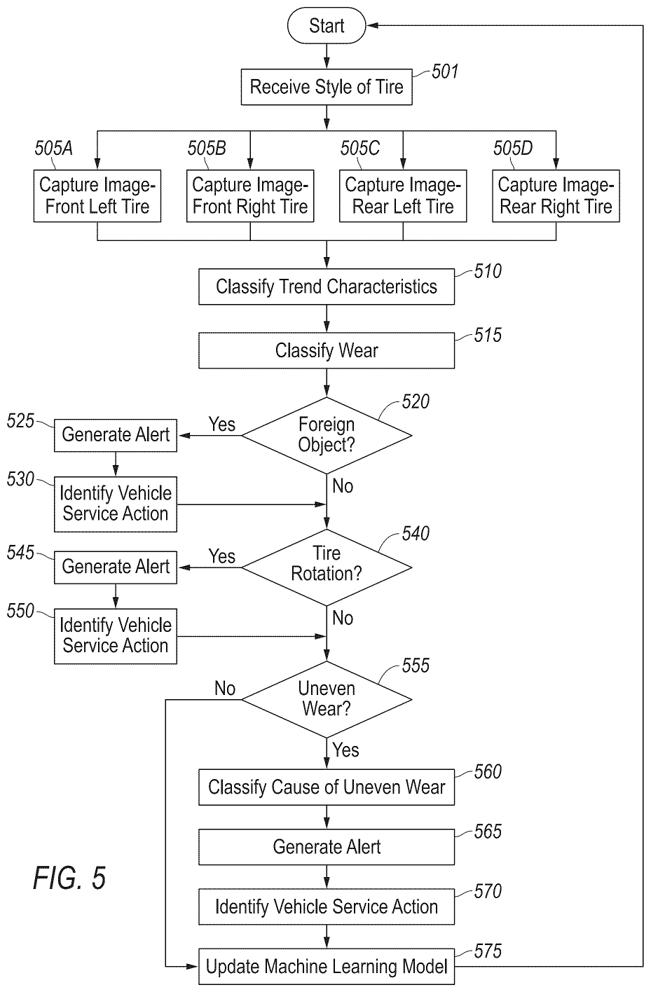

The system 100 performs the method 500 shown in FIG. 5. In examples in which the sensors 140 to detect surface data of the tires 120 is mounted to the vehicle 101 or another vehicle 101, the system 100 may perform the method 500 continuously or periodically to monitor the tread 150 of the four tires 120. In other examples, the system 100 may perform method 500 when prompted, for example by a user of the vehicle 101, a service technician, etc.

The method 500 includes running the machine learning model described above. The machine learning model is initially trained, as described above. Method 500 includes running that trained machine learning model in method 500 for vehicles 101 driven by customers on roadways. That machine learning model is further trained with input from the vehicles 101 and/or service technicians.

The method 500 includes operating the machine learning model based on the style of tire 120. The machine learning model may have different datasets for different styles of tires 120, as set forth above, and the method 500 may use a dataset specific to the style of tires 120 on the vehicle 101 during each application of method 500. In block 501, the method 500 identifies the style of tire 120 subject to the current application of method 500. As one example, the style of the tire 120 may be identified by surface data recognition based on the surface data captured in blocks 505A-D. For example, the surface data collected in blocks 505A-D may include a marking on the tire 120 of the tire 120 identification number (TIN). In other examples, the style of tire 120 may be included in vehicle 101 information accessible by the system 100.

The method 500 includes receiving surface data of a tread area of a vehicle tire 120 on the vehicle 101. Specifically, the method 500 may include receiving data of tread areas of all four of the tires 120, as shown in blocks 505A, 505B, 505C, and 505D. As set forth above, the surface data is detected by one or more sensors 140. For example, the surface data may be an image captured by an image sensor or lidar data captured by a lidar sensor.

With reference to block 510, the method 500 includes classifying tread characteristics for each tire 120 for which the images were captured. Specifically, the method 500 includes running the machine learning model on the surface data to classify tread characteristics of the tread area. As set forth above, the tread characteristics can be, for example, details of the surface of the tire 120, such as sipes 175, inboard tread depth, outboard tread depth, wear bar height, depth of the circumferential grooves 165, etc., and the machine learning model uses the images from blocks 505A-D as inputs to classify the tread characteristics for each tire 120. As set forth above, the running of the machine learning model and the classification of tread characteristics is based on the style of the tire 120, i.e., the dataset of the machine learning model is based on the style of tire 120.

In block 515, the method 500 includes classifying the wear of each tire 120, which is then used to identify service to the vehicle 101. Specifically, the method includes analyzing the tread characteristics classifications for wear patterns of the four tires 120 of the vehicle 101. As examples, the method may include classifying the wear of each tire 120 as “even wear—no action,” “rotate tires,” “replace—worn,” “foreign object detected,” and “uneven wear.”

In blocks 520, 540, and 555, the method 500 uses the classification of wear of the tire 120 determined in the previous blocks. In block 520, if a foreign object (e.g., a nail, screw, etc.) is detected in the tread 150 of one of the tires 120 in the classification in block 515, the method 500 includes generating an alert in block 525 and generating a vehicle service action in block 530, as described above. In block 540, if the tread 150 of one or more of the tires 120 warrants tire rotation based on the classification of wear in block 515, the method 500 includes generating an alert in block 545 and generating a vehicle service action in block 550, as described above.

In block 555, the method determines whether one of the tires 120 has uneven wear based on the classification of tread characteristics in block 510 and/or the classification of wear in block 515, as described above. As set forth above, identifying the cause of uneven wear of any one of the tires 120 includes both analyzing the tread characteristics classifications of that tire 120 as well as the tread characteristics classifications of the other tires 120 of the vehicle 101.

If uneven wear is determined in block 555, the method 500 includes generating an alert in block 565 and identifying a vehicle service action in block 570, as described above. As set forth above, the vehicle service action may include detailed instructions for a service technician. As an example, the detailed instructions may include specifications for adjustment of vehicle 101 components. The method 500 may include providing the vehicle service action and a detailed description for the service technician in an interactive service manual.

In block 575, the method 500 includes training the machine learning model based on uses of the method 500 on vehicles 101 in the field. The machine learning model may be trained with the surface data, classification of the tread characteristics, the identification of uneven wear, and/or the identification of the cause of uneven wear, as described above. The method 500 also includes receiving input from a service technician who has inspected the vehicle 101 during vehicle service resulting from the alert and identification of a vehicle service action. The service technician, for example, may confirm or dispute the classification of the tread characteristics, the identification of uneven wear, and/or the identification of the cause of uneven wear based on physical inspection of the vehicle 101 by the service technician.

As set forth above, after the machine learning model is further trained in block 575, the trained machine learning model is run in future applications of the method 500. Thus, the machine learning model is continuously updated through use in the field.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system 100, the Microsoft Windows® operating system 100, the Unix operating system 100 (e.g., the Solaris® operating system 100 distributed by Oracle Corporation of Redwood Shores, California), the AIX UNIX operating system 100 distributed by International Business Machines of Armonk, New York, the Linux operating system 100, the Mac OSX and iOS operating systems distributed by Apple Inc. of Cupertino, California, the BlackBerry OS distributed by Blackberry, Ltd. of Waterloo, Canada, and the Android operating system 100 developed by Google, Inc. and the Open Handset Alliance, or the QNX® CAR Platform for Infotainment offered by QNX Software Systems. Examples of computing devices include, without limitation, an on-board vehicle computer 105, a computer workstation, a server, a desktop, notebook, laptop, or handheld computer, or some other computing system 100 and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system 100 bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system 100 (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system 100 may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system 100 elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. The numerical adjectives “first,” “second,” “third,” etc., are used throughout this document as identifiers and do not indicate importance, order, or quantity. Use of “in response to,” “upon determining,” etc., indicates a causal relationship, not merely a temporal relationship. Many modifications and variations of the present disclosure are possible in light of the above teachings, and the disclosure may be practiced otherwise than as specifically described.

What is claimed is:

1. A system comprising a computer including a processor and memory, the memory storing instructions executable by the processor to:
receive surface data of a tread area of a vehicle tire on a vehicle;
run a machine learning model on the surface data to classify tread characteristics of the tread area;
identify uneven wear on the vehicle tire based on the classifications of tread characteristics of the tread area;
identify a cause of the uneven wear on the vehicle tire based on the classification of tread characteristics of the tread area; and
generate an alert indicating the cause of the uneven wear.

2. The system as set forth in claim 1, wherein the tread characteristics include at least one of sipe presence, inboard tread block height, outboard tread block height, and wear bar exposure.

3. The system as set forth in claim 1, wherein the instructions to identify the cause of uneven wear of the tire include instructions to compare the classifications of tread characteristics of the tread area of the tire with classifications of tread characteristics of a tread area of another tire of the vehicle.

4. The system as set forth in claim 1, wherein the instructions include instructions to receive an identification of a style of the tire, and wherein the instructions to run the machine learning model includes instructions to classify the tread characteristics based on the style of tire.

5. The system as set forth in claim 1, wherein the instructions include instructions to train the machine learning model with the classification of the tread characteristics, the identification of uneven wear, and/or the identification of the cause of uneven wear.

6. The system as set forth in claim 1, wherein the instructions include instructions to identify a vehicle service action based on the cause of uneven wear on the vehicle tire.

7. The system as set forth in claim 6, wherein the instructions include instructions to receive service technician input verifying the vehicle service action.

8. The system as set forth in claim 6, wherein instructions to identify the vehicle service action are based on driving style of a driver of the vehicle.

9. The computer as set forth in claim 1, wherein the surface data is an image detected by an image sensor.

10. The computer as set forth in claim 1, wherein the surface data is three-dimensional data detected by a lidar sensor.

11. A method comprising:
receiving surface data of a tread area of a vehicle tire on a vehicle;
running a machine learning model on the surface data to classify tread characteristics of the tread area;
identifying uneven wear on the vehicle tire based on the classifications of tread characteristics of the tread area;
identifying a cause of the uneven wear on the vehicle tire based on the classification of tread characteristics of the tread area; and
generating an alert indicating the cause of the uneven wear.

12. The method as set forth in claim 11, wherein the tread characteristics include at least one of sipe presence, inboard tread block height, outboard tread block height, and wear bar exposure.

13. The method as set forth in claim 11, wherein identifying the cause of uneven wear of the tire includes comparing the classifications of tread characteristics of the tread area of the tire with classifications of tread characteristics of a tread area of another tire of the vehicle.

14. The method as set forth in claim 11, wherein running the machine learning model includes classifying the tread characteristics based on the style of tire.

15. The method as set forth in claim 11, further comprising training the machine learning model with the classification of the tread characteristics, the identification of uneven wear, and/or the identification of the cause of uneven wear.

16. The method as set forth in claim 11, further comprising identifying a vehicle service action based on the cause of uneven wear on the vehicle tire.

17. The method as set forth in claim 16, further comprising receiving service technician input verifying the vehicle service action.

18. The method as set forth in claim 16, further comprising basing the vehicle service action on a driving style of a driver of the vehicle.
